(19) United States
(12) Patent Application Publication
(10) Pub. No.: US 2006/0012061 A1
(43) Pub. Date: Jan. 19, 2006

(54) Process and composition for the production of carbon fiber and mats

(75) Inventors: Masumi Hirata, Iwakuni-shi (JP); Hiroshi Sakurai, Iwakuni-shi (JP); Toru Sawaki, Iwakuni-shi (JP); Tetsuo Ban, Iwakuni-shi (JP); Satoru Ohmori, Iwakuni-shi (JP); Shunichi Matsumura, Iwakuni-shi (JP); Hideaki Nitta, Iwakuni-shi (JP)

Correspondence Address: SUGHRUE MION, PLLC, 2100 PENNSYLVANIA AVENUE, N.W., SUITE 800, WASHINGTON, DC, 20037, US

(73) Assignee: TEIJIN LIMITED, Osaka-shi (JP)

(21) Appl. No.: 10/529,758

(22) PCT Filed: Sep. 25, 2003
(86) PCT No.: PCT/JP03/12261

§ 371 Date: Mar. 30, 2005

(30) Foreign Application Priority Data
Sep. 30, 2002 (JP) 2002-285209
Oct. 31, 2002 (JP) 2002-317286
Nov. 8, 2002 (JP) 2002-324959
Dec. 11, 2002 (JP) 2002-359120
Jan. 28, 2003 (JP) 2003-018513
Jun. 18, 2003 (JP) 2003-173031

(51) Int. Cl. D01C 5/00; D01D 5/08; D01D 5/10; C08F 8/30

(52) U.S. Cl. 264/29.2; 264/172.18; 264/172.17; 525/178

(57) ABSTRACT

A process for manufacturing a carbon fiber having a fiber diameter of 0.001 to 5 μm and a narrow fiber size distribution, and a resin composition suitable for the manufacture of a carbon fiber. A resin composition comprising 100 parts by weight of a thermoplastic resin, 1 to 150 parts by weight of a carbon precursor organic compound (A) and 0.001 to 40 parts by weight of acopolymer of polymer segments (e1) and (e2) which satisfy a specific range of surface tension for the thermoplastic resin and a specific range of surface tension for the carbon precursor organic compound (A) at the same time. A process for manufacturing a carbon fiber, comprising the steps of producing a molded article of a precursor fiber (B) by treating the resin composition, subjecting the carbon precursor organic compound (A) contained in the precursor fiber (B) to a stabilization treatment so as to produce a stabilized precursor fiber (C), removing the thermoplastic resin contained in the stabilized precursor fiber (C), and carbonizing or graphitizing a fibrous carbon precursor (D) obtained by removing the thermoplastic resin.

### FIELD OF THE INVENTION

The present invention relates to a carbon fiber and a process and composition for manufacturing a mat. More specifically, it relates to a carbon fiber having a very small fiber diameter, for example, 0.001 to 5 μm, a process for manufacturing a mat and a composition used for the manufacture of a mat.

### DESCRIPTION OF THE PRIOR ART

A carbon fiber is used as a filler for high-performance composite materials because it has excellent characteristic properties such as high strength, high elastic modulus, high conductivity and lightweight. As for its use, it is expected to be used not only as a reinforcing filler for the purpose of improving mechanical strength as in the prior art but also as a conductive resin filler for electromagnetic shielding materials and antistatic materials, making use of the high conductivity of a carbon material, or as a filler for electrostatic coatings for resins. It is also expected to be used as a field electron emitting material for flat displays and the like, making use of the characteristic properties of a carbon material such as chemical stability, thermal stability and micro-structure.

Heretofore, the carbon fiber has been manufactured by carbonizing a fibrous carbon precursor such as polyacrylonitrile, pitch or cellulose by heating at a temperature of 1,000° C. or higher. The carbon fiber manufactured by this process is a continuous fiber having a fiber diameter of 5 to 20 μm and the manufacture of a carbon fiber having a fiber diameter smaller than 5 μm is substantially impossible.

Research into a carbon fiber (Vapor Grown Carbon Fiber; to be abbreviated as VGCF hereinafter) manufactured by a vapor phase process was started in the latter half of 1980, and the carbon fiber has been manufactured on an industrial scale. As examples of its production process, JP-A 60-27700 (the term “JP-A” as used herein means an “unexamined published Japanese patent application”) discloses a process for manufacturing a carbon fiber by introducing an organic compound such as benzene as a raw material and an organic transition metal compound such as ferrocene as a catalyst into a high-temperature reaction furnace together with a carrier gas to grow a carbon fiber on a substrate, JP-A 60-54998 discloses a process for growing VGCF in a floating state, and Japanese Patent No. 2778434 discloses a process for growing a carbon fiber on the wall of a reaction furnace. Since VGCF has a small diameter and is not continuous, it physically differs from the carbon fiber of the prior art and has a fiber diameter of several hundreds of nm and a length of several tens of μm. As the fine carbon fiber has higher heat conductivity and electric conductivity and is hardly eroded, it differs from the carbon fiber of the prior art functionally and is greatly expected to be used in a wide variety of fields.

JP-A 2001-73226 discloses a process for manufacturing a fine carbon fiber from a composite fiber of a phenolic resin and polyethylene. Although this process has the possibility of manufacturing a fine carbon fiber at a lower cost than the above vapor phase process, the phenolic resin must be stabilized by a wet process for a long time and is hardly aligned and hardly graphitized, with result that the development of strength and elastic modulus from the obtained fine carbon fiber cannot be expected.

### SUMMARY OF THE INVENTION

It is an object of the present invention to provide a process for manufacturing a carbon fiber.

It is another object of the present invention to provide a process for manufacturing a fine carbon fiber, for example, a fine carbon fiber having a fiber diameter of 0.001 to 5 μm efficiently at a low cost.

It is still another object of the present invention to provide a process for manufacturing a carbon fiber which has few branched structures and high strength and a high elastic modulus efficiently at a low cost.

It is a further object of the present invention to provide a process for manufacturing a carbon fiber mat made of the above carbon fiber, especially a mat made of a fine carbon fiber efficiently at a low cost.

It is a still further object of the present invention to provide a composition for manufacturing a carbon fiber suitably used in the above manufacturing process of the present invention.

It is a still further object of the present invention to provide particularly preferred use of a carbon fiber obtained by the manufacturing process of the present invention.

Other objects and advantages of the present invention will become apparent from the following description.

According to the present invention, firstly, the above objects and advantages of the present invention are attained by a process for manufacturing a carbon fiber, comprising the steps of:
(1) spinning or forming a mixture of 100 parts by weight of a thermoplastic resin and 1 to 150 parts by weight of at least one thermoplastic carbon precursor selected from the group consisting of pitch, polyacrylonitrile, polycarbodiimide, polyimide, polybenzazole and aramide into a precursor fiber or a precursor film;
(2) subjecting the precursor fiber or film to a stabilization treatment to stabilize the thermoplastic carbon precursor contained in the precursor fiber or film so as to form a stabilized precursor fiber or film;
(3) removing the thermoplastic resin from the stabilized precursor fiber or film to form a fibrous carbon precursor; and
(4) carbonizing or graphitizing the fibrous carbon precursor to form a carbon fiber.

According to the present invention, secondly, the above objects and advantages of the present invention are attained by a process for manufacturing a carbon fiber mat, comprising the steps of:
(1) melt extruding a mixture of 100 parts by weight of a thermoplastic resin and 1 to 150 parts by weight of at least one thermoplastic carbon precursor selected from the group consisting of pitch, polyacrylonitrile, polycarbodiimide, polyimide, polybenzazole and aramide to form a precursor film;
(2) subjecting the precursor film to a stabilization treatment to stabilize the thermoplastic carbon precursor contained in the precursor film so as to form a stabilized precursor film;
(3) laminating together a plurality of the stabilized precursor films to form a stabilized precursor laminated film;
(4) removing the thermoplastic resin from the stabilized precursor laminated film to form a fibrous carbon precursor mat; and
(5) carbonizing or graphitizing the fibrous carbon precursor mat to form a carbon fiber mat.

According to the present invention, thirdly, the above objects and advantages of the present invention are attained by a composition for producing fibrous carbon, which comprises 100 parts by weight of a thermoplastic resin and 1 to 150 parts by weight of at least one thermoplastic carbon precursor selected from the group consisting of pitch, acrylonitrile, polycarbodiimide, polyimide, polybenzazole and aramide.

According to the present invention, in the fourth place, the above objects and advantages of the present invention are attained by use of a carbon fiber obtained by the process of the present invention in an electrode for batteries or to be mixed with a resin.

### BRIEF DESCRIPTION OF THE DRAWINGS

FIG. 1 is an SEM photo of the resin composition (PE/pitch/Modiper A1100) of Example 1 (magnification of 10,000×);

FIG. 2 shows the distribution of pitch dispersion particle diameters of the resin composition (PE/pitch/Modiper A1100) of Example 1; and

FIG. 3 shows the dependence on shear rate of the melt viscosities of PE and pitch.

### DETAILED DESCRIPTION OF THE PREFERRED EMBODIMENTS

Preferred embodiments of the present invention will be described hereinunder. The process for manufacturing a carbon fiber will be first described hereinunder.

In the step (1), a mixture of 100 parts by weight of a thermoplastic resin and 1 to 150 parts by weight of a thermoplastic carbon precursor is spun into a precursor fiber or formed into a precursor film.

As the thermoplastic resin is preferably used a thermoplastic resin having a weight reduction in the air at 500° C. measured by TGA of 90% or more and a weight reduction in the air at 1,000° C. of 97% or more because it can be easily removed in the step (3) from the stabilized precursor fiber or film produced in the step (2). Preferably, the thermoplastic resin has a crystal melting point of 100 to 400° C. when it is crystalline and a glass transition temperature of 100 to 250° C. when it is amorphous because it can be easily melt kneaded with the thermoplastic carbon precursor and melt spun.

When the crystal melting point of the crystalline resin is higher than 400° C., melt kneading must be carried out at a temperature of 400° C. or higher, which may cause the decomposition of the resin disadvantageously. When the glass transition point of the amorphous resin is higher than 250° C., it is difficult to handle the resin because the viscosity of the resin at the time of melt kneading is very high. Preferably, the thermoplastic resin has high permeability for gas such as oxygen or halogen gas from another point of view. Therefore, the thermoplastic resin used in the present invention preferably has a free volume diameter at 20° C. evaluated by a positron extinction method of 0.50 nm or more. When the free volume diameter at 20° C. evaluated by the positron extinction method is smaller than 0.50 nm, the permeability for gas such as oxygen or halogen gas deteriorates and the time in the step (2) of stabilizing the carbon precursor contained in the precursor fiber or film to produce a stabilized precursor fiber or film becomes very long, thereby greatly reducing production efficiency. The free volume diameter at 20° C. evaluated by the positron extinction method is more preferably 0.52 nm or more, much more preferably 0.55 nm or more. The upper limit of the free volume diameter is not particularly limited but preferably as large as possible. The preferred range of the free volume diameter is preferably 0.5 to 1 nm, more preferably 0.5 to 2 nm.

The difference in surface tension between the thermoplastic resin and the thermoplastic carbon precursor is preferably 15 mN/m or less. The mixture in the step (1) is formed by blending the thermoplastic resin with the carbon precursor. Therefore, when the difference in surface tension between the carbon precursor and the thermoplastic resin is larger than 15 mN/m, the dispersibility in the thermoplastic resin of the carbon precursor lowers and also the carbon precursor readily agglomerates in the thermoplastic resin. The difference in surface tension between the thermoplastic resin and the carbon precursor is more preferably 10 mN/m or less, particularly preferably 5 mN/m or less.

The thermoplastic resin having the above characteristic feature is, for example, a polymer represented by the following formula (I): 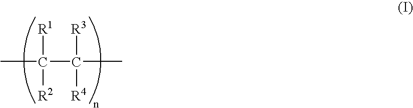
wherein R¹, R², R³ and R⁴ are each independently a hydrogen atom, alkyl group having 1 to 15 carbon atoms, cycloalkyl group having 5 to 10 carbon atoms, aryl group having 6 to 12 carbon atoms or aralkyl group having 7 to 12 carbon atoms, and n is an integer of 20 or more, preferably 20 to 100,000.

The thermoplastic resin represented by the above formula (I) is selected from polyethylene, amorphous polyolefin, a homopolymer of 4-methylpentene-1 and a copolymer of 4-methylpentene-1 and other olefin such as a copolymer of poly-4-methylpentene-1 and a vinyl-based monomer. Examples of the polyethylene include hompolymers of ethylene and copolymers of ethylene and an α-olefin such as high-pressure low-density polyethylene, intermediate-density polyethylene, high-density polyethylene and linear low-density polyethylene; and copolymers of ethylene and other vinyl-based monomer such as a copolymer of ethylene and vinyl acetate. Examples of the α-olefin to be copolymerized with ethylene include propylene, 1-butene, 1-hexene and 1-octene. Examples of the other vinyl-based monomer include vinyl esters such as vinyl acetate; and (meth)acrylic acids and alkyl esters thereof such as (meth)acrylic acid, methyl (meth)acrylate, ethyl (meth)acrylate and n-butyl (meth)acrylate.

The thermoplastic carbon precursor used in the present invention is selected from pitch, polyacrylonitrile, polycarbodiimide, polyimide, polybenzazole and aramide. They are easily carbonized or graphitized at a high temperature of 1,000° C. or higher. Out of these, pitch, polyacrylonitrile and polycarbodiimide are preferred, and pitch is more preferred. Meso-phase pitch which is generally expected to have high strength and high elastic modulus is particularly preferred.

The pitch is a mixture of condensation polycyclic aromatic hydrocarbons which are obtained as the residue of coal or oil after distillation or as raw materials and is generally amorphous and optically isotropic (generally called “isotropic pitch”). When this isotropic pitch having steady properties is heated in an inert gas atmosphere at 350 to 500° C., it may be converted into meso-phase pitch including nematic-phase pitch liquid crystals, which shows anisotropy optically in the end through various stages. The meso-phase pitch may be obtained from an aromatic hydrocarbon such as benzene or naphthalene. The meso-phase pitch may also be called “isotropic pitch” or “liquid crystal pitch” from its characteristic properties. The meso-phase pitch is preferably obtained from an aromatic hydrocarbon such as naphthalene because it is easily stabilized and carbonized or graphitized. The above thermoplastic carbon precursors may be used alone or in combination of two or more.

The thermoplastic carbon precursor is used in an amount of 1 to 150 parts by weight, preferably 5 to 100 parts by weight based on 100 parts by weight of the thermoplastic resin. When the amount of the carbon precursor is larger than 150 parts by weight, a precursor fiber or film having a desired dispersion diameter cannot be obtained and when the amount is smaller than 1 part by weight, the target fine carbon fiber cannot be produced at a low cost disadvantageously.

In order to produce a mixture of the thermoplastic resin and the carbon precursor organic compound (A), it is preferred to knead them together in a molten state. Particularly, the ratio (η_{M}/η_{A}) of the melt viscosity (η_{M}) of the thermoplastic resin to the melt viscosity (η_{A}) of the thermoplastic carbon precursor at the time of melt kneading is preferably 0.5 to 50. Even when the ratio (η_{M}/η_{A}) is smaller than 0.5 or larger than 50, the dispersibility in the thermoplastic resin of the thermoplastic carbon precursor becomes unsatisfactory. The ratio (η_{M}/η_{A}) is more preferably 0.7 to 5. To melt knead the thermoplastic resin with the thermoplastic carbon precursor, a known kneading machine such as a single-screw extruder, double-screw extruder, mixing roll or Banbury mixer may be used. Out of these, a same-direction double-screw extruder is preferably used to disperse the thermoplastic carbon precursor into the thermoplastic resin finely. The melt kneading temperature is, for example, 100 to 400° C., When the melt kneading temperature is lower than 100° C., the thermoplastic carbon precursor does not melt, thereby making it difficult to disperse it into the thermoplastic resin finely. When the temperature is higher than 400° C., the decomposition of the thermoplastic resin and the thermoplastic carbon precursor proceeds disadvantageously. The melt kneading temperature is preferably in the range of 150 to 300° C. The melt kneading time is 0.5 to 20 minutes, preferably 1 to 15 minutes. When the melt kneading time is shorter than 0.5 minute, it is difficult to disperse the thermoplastic carbon precursor finely. When the melt kneading time is longer than 20 minutes, the productivity of the fine carbon fiber greatly drops disadvantageously. The melt kneading of the thermoplastic resin and the thermoplastic carbon precursor is preferably carried out in an atmosphere containing less than 10% of oxygen gas. When the thermoplastic carbon precursor used in the present invention is reacted with oxygen, it is modified and infusible at the time of melt kneading, whereby the fine dispersion of the thermoplastic carbon precursor into the thermoplastic resin may be impeded. Therefore, it is preferred that melt kneading should be carried out by circulating an inert gas to reduce the content of oxygen gas as much as possible. The content of oxygen gas at the time of melt kneading is preferably less than 5%, more preferably less than 1%.

The above mixture of the thermoplastic resin and the thermoplastic carbon precursor may contain a compatibilizing agent for the thermoplastic resin and the thermoplastic carbon precursor. The compatibilizing agent is preferably added at the time of melt kneading.

The compatibilizing agent is preferably a polymer selected from (E) a copolymer of a polymer segment (e1) which satisfies the following expression (1) and a polymer segment (e2) which satisfies the following expression (2):
0.7<(surface tension of polymer segment (e1))/(surface tension of thermoplastic carbon precursor)<1.3 (1)
0.7<(surface tension of polymer segment (e2))/(surface tension of thermoplastic resin)<1.3 (2)
and (F) a homopolymer which satisfies the following expressions (3) and (4):
0.7<(surface tension of homopolymer (F))/(surface tension of thermoplastic carbon precursor)<1.3 (3)
0.7<(surface tension of homopolymer (F))/(surface tension of thermoplastic resin)<1.3 (4).

When the above compatibilizing agent is used, the dispersion particle diameter of the thermoplastic carbon precursor in the thermoplastic resin becomes small and the particle size distribution thereof becomes narrow, whereby the finally obtained carbon fiber becomes finer and has a narrower fiber size distribution than the carbon fiber of the prior art.

Consequently, even when the amount of the carbon precursor based on the thermoplastic resin gradually increases, it can be avoided that the both materials contact each other and fuse together immediately.

The above expression (1) for the above copolymer (E) represents the ratio of the surface tension of the thermoplastic carbon precursor to the surface tension of the polymer segment (e1). That is, it shows the parameter of interfacial surface energy between the polymer segment (e1) and the carbon precursor. When this ratio is smaller than 0.7 or larger than 1.3, interfacial tension between the polymer segment (e1) and the carbon precursor becomes high and therefore, interfacial adhesion between the two phases becomes unsatisfactory. The ratio of the surface tension of the carbon precursor to the surface tension of the polymer segment (e1) is preferably 0.75 to 1.25, more preferably 0.8 to 1.2. The polymer segment (e1) is not particularly limited if it satisfies the above expression (1). Preferred examples of the polymer segment (e1) include polyolefin-based homopolymers and copolymers such as polyethylene, polypropylene and polystyrene, and polyacrylate-based homopolymers and copolymers such as polymethacrylate and polymethyl methacrylate. Styrene copolymers such as acrylonitrile-styrene copolymer and acrylonitrile-butylene-styrene copolymer may also be used. Out of these, styrene homopolymers and copolymers are preferred.

The above expression (2) for the copolymer (E) represents the ratio of the surface tension of the thermoplastic resin to the surface tension of the polymer segment (e2). That is, it shows the parameter of interfacial surface energy between the polymer segment (e2) and the thermoplastic resin. When this ratio is smaller than 0.7 or larger than 1.3, interfacial tension between the polymer segment (e2) and the thermoplastic resin becomes high and therefore, interfacial adhesion between the two phases becomes unsatisfactory. The ratio of the surface tension of the thermoplastic resin to the surface tension of the polymer segment (e2) is preferably 0.75 to 1.25, more preferably 0.8 to 1.2. The polymer segment (e2) is not particularly limited if it satisfies the above expression (2). Preferred examples of the polymer segment (e2) include polyolefin-based homopolymers and copolymers such as polyethylene, polypropylene and polystyrene, and polyacrylate-based homopolymers and copolymers such as polymethacrylate and polymethyl methacrylate. Copolymers such as acrylonitrile-styrene copolymer and acrylonitrile-butylene-styrene copolymer may also be used. Out of these, ethylene homopolymers and copolymers are preferred.

The above copolymer (E) may be a graft copolymer or block copolymer. As for the preferred ratio of the polymer segment (e1) and the polymer segment (e2), the amount of the polymer segment (e1) is 10 to 90 wt % and the amount of the polymer segment (e2) is 90 to 10 wt %. Examples of the copolymer of such two different polymer segments include a copolymer of polyethylene and polystyrene, copolymer of polypropylene and polystyrene, copolymer of an ethylene-glycidyl methacrylate copolymer and polystyrene, copolymer of an ethylene-ethyl acrylate copolymer and polystyrene, copolymer of an ethylene-vinyl acetate copolymer and polystyrene, copolymer of polyethylene and polymethyl methacrylate, copolymer of an ethylene-glycidyl methacrylate copolymer and polymethyl methacrylate, copolymer of an ethylene-ethyl acrylate copolymer and polymethyl methacrylate, copolymer of an ethylene-vinyl acetate copolymer and polymethyl methacrylate, copolymer of an acrylonitrile-styrene copolymer and polyethylene, copolymer of an acrylonitrile-styrene copolymer and polypropylene, copolymer of an acrylonitrile-styrene copolymer and an ethylene-glycidyl methacrylate copolymer, copolymer of an acrylonitrile-styrene copolymer and an ethylene-ethyl acrylate copolymer, and copolymer of an acrylonitrile-styrene copolymer and an ethylene-vinyl acetate copolymer.

Further, the above expression (3) for the above homopolymer (F) can be understood likewise when the polymer segment (e1) in the above expression (1) is substituted by the homopolymer (F). The above expression (4) can also be understood likewise when the polymer segment (e2) in the above expression (2) is substituted by the homopolymer (F). Examples of the homopolymer (F) include polyolefin-based homopolymers such as polyethylene, polypropylene and polystyrene; and polyacrylate-based homopolymers such as polymethacrylate and polymethyl methacrylate.

The amount of the above compatibilizing agent is preferably 0.001 to 40 parts by weight, more preferably 0.001 to 20 parts by weight based on 100 parts by weight of the thermoplastic resin.

The dispersion diameter of the carbon precursor into the thermoplastic resin in the thus formed mixture used in the step (1) is preferably 0.01 to 50 μm. The carbon precursor in the mixture forms an island phase and becomes spherical or oval. The term “dispersion diameter” as used herein means the diameter of the spherical carbon precursor or the diameter of the long axis of the oval carbon precursor in the mixture.

When the dispersion diameter of the carbon precursor into the thermoplastic resin is outside the range of 0.01 to 50 μm, it is difficult to produce a carbon fiber filler for use in high-performance composite materials. The dispersion diameter of the carbon precursor is more preferably in the range of 0.01 to 30 μm. Even after the mixture of the thermoplastic resin and the carbon precursor is heated at 300° C. for 3 minutes, the dispersion diameter of the carbon precursor into the thermoplastic resin is preferably 0.01 to 50 μm. When the mixture obtained by melt kneading the thermoplastic resin with the carbon precursor is kept molten, the carbon precursor agglomerates along the passage of time. When the dispersion diameter exceeds 50 μm due to the agglomeration of the carbon precursor, it is difficult to produce a carbon fiber filler for use in high-performance composite materials disadvantageously. As for the agglomeration speed of the carbon precursor which changes according to the types of the thermoplastic resin and the carbon precursor in use, the carbon precursor desirably keeps a dispersion diameter of 0.01 to 50 μm preferably for 5 minutes at 300° C., more preferably for 10 minutes or more at 300° C.

In the step (1), the above mixture is spun into a precursor fiber or formed into a precursor film.

To form the precursor fiber, the mixture obtained by melt kneading is melt spun from a spinning nozzle. The spinning temperature for melt spinning is, for example, 100 to 400° C., preferably 150 to 400° C., more preferably 180 to 350° C. The spun yarn take-up rate is preferably 10 m/min to 2,000 m/min. When the spun yarn take-up rate is outside the above range, a desired fibrous molded article (precursor fiber) of the mixture may not be obtained disadvantageously. In order to melt knead and then melt spin the mixture from the spinning nozzle, after it is melt kneaded, it is preferably supplied by a pipe while it is molten and melt spun from the spinning nozzle. The transfer time from melt kneading to delivery from the spinning nozzle is preferably 10 minutes or less.

The sectional form of the precursor fiber may be circular or other form, and the circle-equivalent diameter thereof is preferably 1 to 100 μm.

Methods for forming the precursor film include one in which the mixture is sandwiched between two plates and one of the plates is turned to form a sheared film, one in which stress is quickly applied to the mixture by a compression press to form a sheared film, and one in which a rotary roller is used to form a sheared film. The shear is in the range of 1 to 100,000 S⁻¹. The formation of the precursor film may be carried out by melt extruding the mixture from a slit. The melt extrusion temperature is preferably 100 to 400° C.

The precursor fiber or the precursor film in which the carbon precursor is elongated may be produced by stretching a fiber-like or film-like molded article in a molten state or softened state. These treatments are carried out preferably at 150 to 400° C., more preferably at 180 to 350° C.

The thickness of the precursor film is preferably 1 to 500 μm. When the thickness is larger than 500 μm, gas permeability greatly deteriorates in the following step (2) for contacting the precursor film to oxygen and/or gas containing iodine gas to obtain a stabilized precursor film, whereby it takes long to obtain the stabilized precursor film. When the thickness is smaller than 1 μm, the handling of the precursor film becomes difficult disadvantageously.

According to the present invention, in the step (1), there is provided a composition for producing fibrous carbon, which comprises 100 parts by weight of the thermoplastic resin and 1 to 150 parts by weight of at least one thermoplastic carbon precursor selected from the group consisting of pitch, acrylonitrile, polycarbodiimide, polyimide, polybenzazole and aramide as described above.

The above composition may further contain one or more of a copolymer (E) of a polymer segment (e1) which satisfies the above expression (1) and a polymer segment (e2) which satisfies the above expression (2) and a homopolymer (F) which satisfies the above expressions (3) and (4) in an amount of 0.001 to 20 parts by weight.

The composition is substantially composed of 100 parts by weight of the thermoplastic resin and 1 to 150 parts by weight of the thermoplastic carbon precursor or may be substantially composed of 100 parts by weight of the thermoplastic resin, 1 to 150 parts by weight of the thermoplastic carbon precursor and 0.001 to 20 parts by weight of the above copolymer (E) and/or the homopolymer (F).

Preferably, (i) the thermoplastic carbon precursor is dispersed in the thermoplastic resin matrix in a particulate form and the average equivalent particle diameter of the dispersed thermoplastic carbon precursor is in the range of 0.01 to 50 μm, (ii) after the composition is heated at 300° C. for 3 minutes, the average equivalent particle diameter of the dispersed thermoplastic carbon precursor is in the range of 0.01 to 50 μm, or (iii) the composition is prepared by mixing the thermoplastic resin with the thermoplastic carbon precursor at a temperature at which the melt viscosity of the thermoplastic resin is 0.5 to 30 times higher than the melt viscosity of the thermoplastic carbon precursor at a shear rate of 1,000 S⁻¹.

In the following step (2) of the present invention, the precursor fiber or film is subjected to a stabilization treatment to stabilize the thermoplastic carbon precursor contained in the precursor fiber or film so as to form a stabilized precursor fiber or film.

The stabilization of the thermoplastic carbon precursor is a necessary step for obtaining a carbonized or graphitized fine carbon fiber. When the thermoplastic resin and the copolymer are removed without carrying out this step, the thermoplastic carbon precursor thermally decomposes or fuses. For stabilization, a known treatment such as a treatment with a gas stream such as oxygen or a solution treatment with an acid aqueous solution may be used. From the viewpoint of productivity, stabilization by a treatment with a gas stream (infusibilization) is preferred. The gas component in use is preferably oxygen and/or mixed gas containing halogen gas from the viewpoints of permeability into the above thermoplastic resin and adsorption to the thermoplastic carbon precursor and to make the thermoplastic carbon precursor infusible quickly at a low temperature. Examples of the halogen gas include fluorine gas, chlorine gas, bromine gas and iodine gas. Out of these, bromine gas and iodine gas are particularly preferred. For infusibilization in a gas stream, the precursor fiber or film is treated in a desired gas atmosphere preferably at 50 to 350° C., more preferably at 80 to 300° C. for 5 hours or less, preferably 2 hours or less. The softening point of the thermoplastic carbon precursor contained in the precursor fiber or film is sharply elevated by the above infusibilization but it is preferably 400° C. or higher, more preferably 500° C. or higher to obtain a desired fine carbon fiber.

In the following step (3) of the present invention, a fibrous carbon precursor is formed by removing the thermoplastic resin from the stabilized precursor fiber or film. The removal of the thermoplastic resin is carried out by thermal decomposition or dissolution in a solvent. Which one of the methods should be used depends on the type of the thermoplastic resin in use. For thermal decomposition which differs according to the thermoplastic resin in use, a temperature of preferably 400 to 600° C., more preferably 500 to 600° C. in a gas atmosphere is used. The gas atmosphere may be an inert gas atmosphere such as argon or nitrogen, or an acid gas atmosphere containing oxygen. For dissolution in a solvent which differs according to the thermoplastic resin in use, a solvent having higher solubility is used. Preferred examples of the solvent include methylene chloride and tetrahydrofuran for a polycarbonate and decalin and toluene for polyethylene.

In the final step (4) of the present invention, the fibrous carbon precursor is carbonized or graphitized to form a carbon fiber. The carbonization or graphitization of the fibrous carbon precursor may be carried out by a known method per se. For example, the fibrous carbon precursor is treated at a high temperature in an inert gas atmosphere to be carbonized or graphitized. The inert gas used is nitrogen or argon, and the temperature is preferably 500 to 3,500° C., more preferably 700 to 3,000° C., particularly preferably 800 to 3,000° C. The amount of oxygen for carbonization or graphitization is preferably 20 ppm or less, more preferably 10 ppm or less. The fiber diameter of the obtained fine carbon fiber is preferably 0.001 to 5 μm, more preferably 0.001 to 1 μm.

A carbon fiber which has few branched structures and high strength and high elastic modulus can be produced by carrying out the above process.

A fine carbon fiber having a fiber diameter of 0.001 to 5 μm, for example, is obtained by the above process. A fine carbon fiber obtained from a composite fiber of phenolic resin and polyethylene becomes amorphous and inferior in strength and elastic modulus because the phenolic resin is amorphous. However, the carbon fiber obtained by this process has higher strength and higher elastic modulus than the fine carbon fiber obtained from a composite fiber of phenolic resin and polyethylene as the molecular chain of the carbon fiber is aligned excessively in the axial direction of the fiber. Since the above carbon fiber has fewer branched structures than a carbon fiber obtained by a vapor phase process, a polymer can be reinforced by adding a smaller amount of the carbon fiber than in the prior art.

According to the present invention, there is provided a process for manufacturing a carbon fiber mat which is an assembly of carbon fibers and not an independent carbon fiber by further improving the above process of the present invention.

That is, the process for manufacturing a carbon fiber mat according to the present invention, comprises the steps of:
(1) melt extruding a mixture of 100 parts by weight of a thermoplastic resin and 1 to 150 parts by weight of at least one thermoplastic carbon precursor selected from the group consisting of pitch, polyacrylonitrile, polycarbodiimide, polyimide, polybenzazole and aramide to form a precursor film;
(2) subjecting the precursor film to a stabilization treatment to stabilize the thermoplastic carbon precursor contained in the precursor film to form a stabilized precursor film;
(3) laminating together a plurality of the stabilized precursor films to form a stabilized precursor laminated film;
(4) removing the thermoplastic resin from the stabilized precursor laminated film to form a fibrous carbon precursor mat;
(5) carbonizing or graphitizing the fibrous carbon precursor mat to form a carbon fiber mat.

The above step (1) is the same as the step (1) of forming a precursor film in the process for manufacturing a carbon fiber.

The step (2) is the same as the step (2) of forming a stabilized precursor film in the process for manufacturing a carbon fiber.

In the step (3), a stabilized precursor laminated film is formed by laminating together a plurality of, for example, 2 to 1,000 stabilized precursor films obtained in the step (2).

In the step (4), a fibrous carbon precursor mat is formed by removing the thermoplastic resin from the stabilized laminated film. This step (4) can be carried out by removing the thermoplastic resin in the same manner as in the step (3) of the process for manufacturing a carbon fiber.

In the step (5), the fibrous carbon precursor mat is carbonized or graphitized to form a carbon fiber mat. The carbonization or graphitization of this step (5) can be carried out in the same manner as in the step (4) of the process for manufacturing a carbon fiber.

According to the above process of the present invention, a carbon fiber mat made of fine carbon fibers can be manufactured extremely easily. This carbon fiber mat is very useful as a high-function filter or electrode material for batteries.

### EXAMPLES

The following examples are provided for the purpose of further illustrating the present invention but are in no way to be taken as limiting.

The dispersion particle diameter of the thermoplastic carbon precursor in the thermoplastic resin and the fiber diameter of the precursor fiber were measured with the S-2400 scanning electron microscope (of Hitachi, Ltd.). The strength and elastic modulus of the obtained carbon fiber were measured with the Tensilon RTC-1225A (of A & D/Orientec Co., Ltd.). The surface tensions of the polymer segment (e1), the polymer segment (e2), the thermoplastic carbon precursor and the thermoplastic resin were evaluated by using a reagent used in “Wet Tension Testing Method for Plastic Films and Sheets” specified in JIS K6768. The free volume diameter of the thermoplastic resin was evaluated from the long-life component of a positron life spectrum by using a spherical model expression (Chem. Phys. 63, 51 (1981)) which gives a pore size and ²²Na₂Co₃ as a positron line source. The melting point or glass transition temperature of the thermoplastic resin was measured with DSC2920 (of TA Instruments Co., Ltd.) at a temperature elevation rate of 10° C./min.

The softening point was measured with a micro-melting point measuring instrument. The melt viscosity (η_{M}) of the thermoplastic resin and the melt viscosity (η_{A}) of the thermoplastic carbon precursor at a shear rate at the time of melt kneading were evaluated by the dependence on shear rate of melt viscosity (FIG. 3). The shear rate (SR) at the time of melt kneading was evaluated by using the following equation (3):
(SR)=[2π·D/(n/60)]/C (3)
wherein D is the outer diameter (m) of a screw, n is the revolution (rpm) of the screw, and C is a clearance (m).

### Example 1

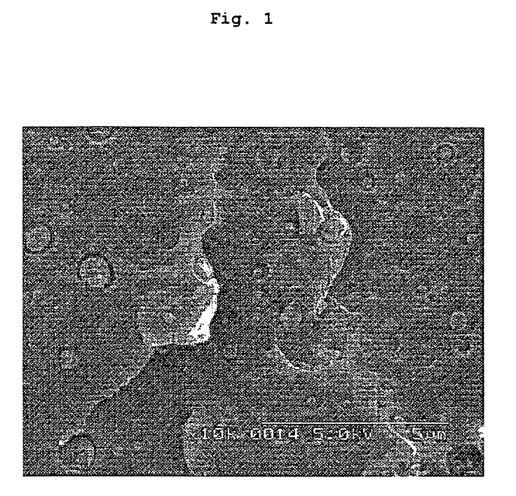

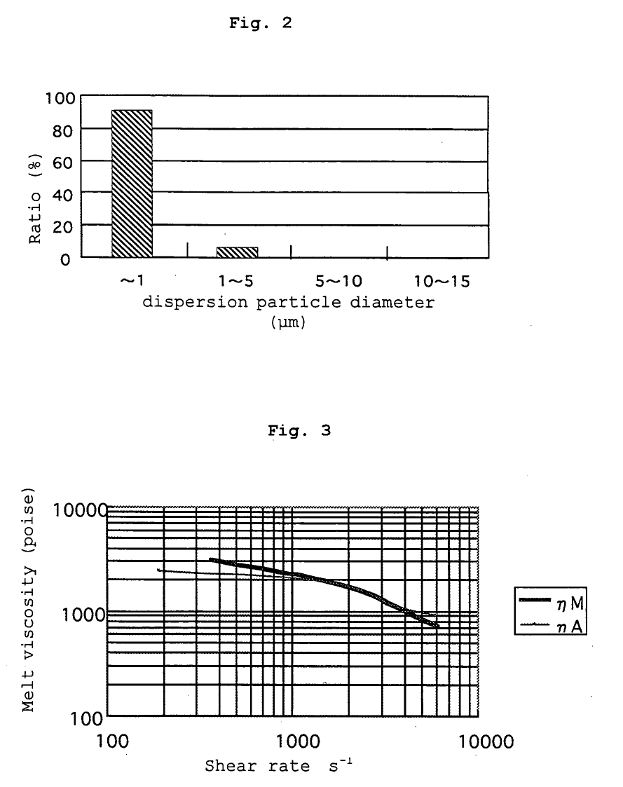

100 parts by weight of high-density polyethylene (of Sumitomo Chemical Co., Ltd.) as a thermoplastic resin, 11.1 parts of the AR-HP meso-phase pitch (of Mitsubishi Gas Chemical Company, Inc.) as a thermoplastic carbon precursor and 0.56 part of the Modiper A1100 (graft copolymer of 70 wt % of low-density polyethylene and 30 wt % of polystyrene, manufactured by NOF Corporation) were melt kneaded together by a same-direction double-screw extruder (TEX-30 of The Japan Steel Works, Ltd., barrel temperature of 290° C., in a stream of nitrogen) to prepare a resin mixture. The shear rate (SR) of the resin mixture at the time of melt kneading was 628 s⁻¹. The ratio (η_{M}/η_{A}) of the melt viscosity (η_{M}) of the thermoplastic resin to the melt viscosity (η_{A}) of the thermoplastic carbon precursor at this shear rate was 1.2. The dispersion diameter of the thermoplastic carbon precursor into the thermoplastic resin obtained under the above conditions was 0.05 to 2 μm (see FIG. 1). When the particle size distribution of the AR-HP was evaluated with a scanning electron microscope, particles having a diameter of less than 1 μm accounted for 90% or more of the total (see FIG. 2). When the resin composition was heated at 300° C. for 10 minutes, the agglomeration of the thermoplastic carbon precursor was not observed and the dispersion diameter thereof was 0.05 to 2 μm. The surface tensions of the high-density polyethylene (of Sumitomo Chemical Co., Ltd.), low-density polyethylene (of Sumitomo Chemical Co., Ltd.), meso-phase pitch and polystyrene were 31, 31, 22 and 24 mN/m, respectively, the value obtained from (surface tension of polymer segment (e1)/surface tension of thermoplastic carbon precursor) was 1.1, and the value obtained from (surface tension of polymer segment (e2)/surface tension of thermoplastic resin) was 1.0.

The above resin mixture was spun from a spinning nozzle at 300° C. to form a precursor fiber (composite fiber). The fiber diameter of this composite fiber was 20 μm, and the dispersion diameter of the meso-phase pitch on the section was all 2 μm or less. 100 parts by weight of the composite fiber and 5 parts by weight of iodine were fed to a pressure glass container and heated at 100° C. for 10 hours to obtain a stabilized precursor fiber. This stabilized precursor fiber was gradually heated to 500° C. to remove the high-density polyethylene and the Modiper A1100. Thereafter, the fiber was heated at 1,500° C. in a nitrogen atmosphere and maintained at that temperature for 30 minutes to be carbonized. The obtained fine carbon fiber had a fiber diameter of 0.01 to 2 μm and a branched structure was rarely observed. When the strength and elastic modulus of the fine carbon fiber having a fiber diameter of 1 μm were measured, the fine carbon fiber had a tensile strength of 2,500 MPa and an elastic modulus in tension of 300 GPa.

### Example 2

100 parts by weight of high-density polyethylene (of Sumitomo Chemical Co., Ltd.) as a thermoplastic resin, 66.7 parts of the AR-HP meso-phase pitch (of Mitsubishi Gas Chemical Company, Inc.) as a thermoplastic carbon precursor and 0.56 part of the Modiper A1100 (graft copolymer of 70 wt % of low-density polyethylene and 30 wt % of polystyrene, manufactured by NOF Corporation) were melt kneaded together by a same-direction double-screw extruder (TEX-30 of The Japan Steel Works, Ltd., barrel temperature of 290° C., in a stream of nitrogen) to prepare a resin mixture. The shear rate (SR) of the resin mixture at the time of melt kneading was 628 s⁻¹. The ratio (η_{M}/η_{A}) of the melt viscosity (η_{M}) of the thermoplastic resin to the melt viscosity (η_{A}) of the thermoplastic carbon precursor at this shear rate was 1.2. The dispersion diameter of the thermoplastic carbon precursor into the thermoplastic resin obtained under the above conditions was 0.05 to 2 μm. When the particle size distribution of the AR-HP was evaluated by a scanning electron microscope, particles having a diameter of less than 1 μm accounted for 90% or more of the total. When the resin mixture was heated at 300° C. for 10 minutes, the agglomeration of the thermoplastic carbon precursor was not observed and the dispersion diameter thereof was 0.05 to 2 μm. The surface tensions of the high-density polyethylene (of Sumitomo Chemical Co., Ltd.), low-density polyethylene (of Sumitomo Chemical Co., Ltd.), meso-phase pitch and polystyrene were 31, 31, 22 and 24 mN/m, respectively, the value obtained from (surface tension of polymer segment (e1)/surface tension of thermoplastic carbon precursor) was 1.1, and the value obtained from (surface tension of polymer segment (e2)/surface tension of thermoplastic resin) was 1.0.

The above resin mixture was spun from the spinning nozzle at 300° C. to form a precursor fiber (composite fiber). The fiber diameter of this composite fiber was 20 μm, and the dispersion diameter of the meso-phase pitch on the section was all 2 μm or less. 100 parts by weight of the composite fiber and 5 parts by weight of iodine were fed to a pressure glass container and heated at 100° C. for 10 hours to obtain a stabilized precursor fiber. This stabilized precursor fiber was gradually heated to 500° C. to remove the high-density polyethylene and the Modiper A1100. Thereafter, the fiber was heated at 1,500° C. in a nitrogen atmosphere and maintained at that temperature for 30 minutes to be carbonized. The obtained fine carbon fiber had a fiber diameter of 0.01 to 2 μm, and a branched structure was rarely observed. When the strength and elastic modulus of the fine carbon fiber having a fiber diameter of 1 μm were measured, the fine carbon fiber had a tensile strength of 2,500 MPa and an elastic modulus in tension of 300 GPa.

### Example 3

100 parts by weight of poly-4-methylpentene-1 (TPX: grade RT-18 [of Mitsui Chemicals, Inc.]) as a thermoplastic resin and 11.1 parts of the AR-HP meso-phase pitch (of Mitsubishi Gas Chemical Company, Inc.) as a thermoplastic carbon precursor were melt kneaded together by a same-direction double-screw extruder (TEX-30 of The Japan Steel Works, Ltd., barrel temperature of 290° C., in a stream of nitrogen) to prepare a resin mixture. The dispersion diameter of the thermoplastic carbon precursor into the thermoplastic resin obtained under the above conditions was 0.05 to 2 μm. When the resin mixture was heated at 300° C. for 3 minutes, the agglomeration of the thermoplastic carbon precursor was not observed and the dispersion diameter thereof was 0.05 to 2 μm. The surface tensions of the poly-4-methylpentene-1 and the meso-phase pitch were 24 and 22 mN/m, respectively. The average diameter of the free volume of the poly-4-methylpentene-1 evaluated by the positron extinction method was 0.64 nm, and the crystal melting point evaluated by DSC thereof was 238° C.

The above resin mixture was spun from the spinning nozzle at 300° C. to form a precursor fiber (composite fiber). The fiber diameter of this composite fiber was 20 μm, and the dispersion diameter of the meso-phase pitch on the section was all 2 μm or less. 100 parts by weight of the composite fiber and 10 parts by weight of iodine were fed to a pressure glass container and heated at 190° C. for 2 hours to obtain a stabilized precursor fiber. This stabilized precursor fiber was gradually heated to 500° C. to remove the poly-4-methylpentene-1. Thereafter, the fiber was heated at 1,500° C. in a nitrogen atmosphere and maintained at that temperature for 30 minutes to be carbonized. The obtained fine carbon fiber had a fiber diameter of 0.01 to 2 μm and a branched structure was rarely observed. When the strength and elastic modulus of the fine carbon fiber having a fiber diameter of 1 μm were measured, the fine carbon fiber had a tensile strength of 2,500 MPa and an elastic modulus in tension of 300 GPa.

### Example 4

100 parts by weight of high-density polyethylene (of Sumitomo Chemical Co., Ltd.) as a thermoplastic resin and 11.1 parts of the AR-HP meso-phase pitch (of Mitsubishi Gas Chemical Company, Inc.) as a thermoplastic carbon precursor were melt kneaded together by a double-screw extruder (TEX-30 of The Japan Steel Works, Ltd., L/D=42, barrel temperature of 290° C., in a stream of nitrogen) to prepare a resin mixture. The dispersion diameter of the thermoplastic carbon precursor into the thermoplastic resin was 0.1 to 10 μm. When the resin mixture was heated at 300° C. for 10 minutes, the agglomeration of the thermoplastic carbon precursor was not observed and the dispersion diameter thereof was 0.1 to 10 μm. The above resin mixture was sandwiched between quartz plates heated at 300° C. and sheared at 750 s⁻¹ for 1 minute with a heating shear and flow observation device (CSS-450A of Japan Hi-tech Co., Ltd.) and quenched to room temperature to form a 60 μm-thick film. When the thermoplastic carbon precursor contained in the film was observed by the above device, it was confirmed that a fiber having a diameter of 0.01 to 5 μm and a length of 1 to 20 μm was formed. Thereafter, 100 parts by weight of this film and 5 parts by weight of iodine were fed to a pressure glass container and heated at 100° C. for 10 hours to obtain a stabilized precursor film. This stabilized precursor film was gradually heated to 500° C. to remove the high-density polyethylene. Thereafter, the film was heated at 1,500° C. in a nitrogen atmosphere and maintained at that temperature for 30 minutes to carbonize the AR-HP. The obtained fine carbon fiber had a fiber diameter of 0.01 to 5 μm, and a branched structure was rarely observed.

### Example 5

100 parts by weight of high-density polyethylene (of Sumitomo Chemical Co., Ltd.) as a thermoplastic resin and 11.1 parts of the AR-HP meso-phase pitch (of Mitsubishi Gas Chemical Company, Inc.) as a thermoplastic carbon precursor were melt kneaded together by a double-screw extruder (TEX-30 of The Japan Steel Works, Ltd., L/D=42, barrel temperature of 290° C., in a stream of nitrogen) to prepare a resin mixture. The dispersion diameter of the thermoplastic carbon precursor into the thermoplastic resin was 0.1 to 10 μm. When the resin mixture was heated at 300° C. for 10 minutes, the agglomeration of the thermoplastic carbon precursor was not observed and the dispersion diameter thereof was 0.1 to 10 μm. The melt viscosity of the thermoplastic resin at 300° C. and a shear rate of 1,000 s⁻¹ was 10 times higher than that of the AR-HP meso-phase pitch.

The above resin mixture was spun from the spinning nozzle at 300° C. to form a precursor fiber (composite fiber). The fiber diameter of this composite fiber was 20 μm, and the dispersion diameter of the AR-HP on the section was all 10 μm or less. 100 parts by weight of the composite fiber and 5 parts by weight of iodine were fed to a pressure glass container and heated at 100° C. for 10 hours to obtain a stabilized precursor fiber. This stabilized precursor fiber was gradually heated to 500° C. to remove the high-density polyethylene. Thereafter, the fiber was heated at 1,500° C. in a nitrogen atmosphere and maintained at that temperature for 30 minutes to carbonize the AR-HP. The obtained fine carbon fiber had a fiber diameter of 0.01 to 5 μm, and a branched structure was rarely observed. When the strength and elastic modulus of the fine carbon fiber having a fiber diameter of 1 μm were measured, the fine carbon fiber had a tensile strength of 2,500 MPa and an elastic modulus in tension of 300 GPa.

### Example 6

100 parts by weight of high-density polyethylene (of Sumitomo Chemical Co., Ltd.) as a thermoplastic resin and 10 parts by weight of the AR-HP meso-phase pitch (of Mitsubishi Gas Chemical Company, Inc.) as a thermoplastic carbon precursor were melt kneaded together by a double-screw extruder (TEX-30 of The Japan Steel Works, Ltd., L/D=42, barrel temperature of 290° C., in a stream of nitrogen), and the obtained resin mixture was supplied by a gear pump in a molten state and spun from the spinning nozzle to obtain a precursor fiber. The precursor fiber had a fiber diameter of 20 μm, and the dispersion diameter of the AR-HP on the section was all 10 μm or less.

100 parts by weight of this precursor fiber and 5 parts by weight of iodine were fed to a pressure glass container and heated at 100° C. for 10 hours. The high-density polyethylene contained in the obtained stabilized precursor fiber was removed with hot toluene as a solvent. When the softening point of the AR-HP was measured, it was 500° C. or higher.

This stabilized precursor fiber was gradually heated to 500° C. to remove the high-density polyethylene. Thereafter, the fiber was heated at 1,500° C. in a nitrogen atmosphere and maintained at that temperature for 30 minutes to carbonize the AR-HP. The obtained fine carbon fiber had a fiber diameter of 0.01 to 5 μm. The carbon fiber targeted by the present invention could be thus obtained. The strength and elastic modulus of the fine carbon fiber having a fiber diameter of 1 μm were measured. The results are shown in Table 1.

### Comparative Example 1

100 parts by weight of phenolic resin as a thermoplastic carbon precursor and 100 parts by weight of high-density polyethylene were melt kneaded together by a double-screw extruder, and the obtained resin mixture was supplied by a gear pump in a molten state and spun from the spinning nozzle to obtain a precursor fiber. The obtained precursor fiber was immersed in an aqueous solution of hydrochloric acid and formaldehyde (18 wt % of hydrochloride acid, 10 wt % of formaldehyde) to obtain a stabilized precursor fiber. This fiber was carbonized at 600° C. for 10 minutes in a stream of nitrogen to remove the polyethylene so as to obtain a phenolic fine carbon fiber. The strength and elastic modulus of the fine carbon fiber having a fiber diameter of 1 μm were measured. The results are shown in Table 1.

### Comparative Example 2

A fiber made of the AR-HP alone was obtained by spinning only the AR-HP in accordance with the same method as the spinning method for obtaining a precursor fiber in Example 6.

Stabilization and graphitization were carried out under the same conditions as in Example 6 to obtain a carbon fiber having a fiber diameter of 15 μm. The results are shown in Table 1.

TABLE 1

| | | | elastic modulus |
|---|---|---|---|
| | Fiber diameter | tensile strength | in tension |
| | (μm) | (MPa) | (GPa) |
| Example 6 | 1 | 2500 | 300 |
| C. Ex. 1 | 1 | 700 | 25 |
| C. Ex. 2 | 15 | 2000 | 200 |

C. Ex.: Comparative Example

1. A process for manufacturing a carbon fiber, comprising the steps of:
(1) spinning or forming a mixture of 100 parts by weight of a thermoplastic resin and 1 to 150 parts by weight of at least one thermoplastic carbon precursor selected from the group consisting of pitch, polyacrylonitrile, polycarbodiimide, polyimide, polybenzazole and aramide into a precursor fiber or a precursor film;
(2) subjecting the precursor fiber or film to a stabilization treatment to stabilize the thermoplastic carbon precursor contained in the precursor fiber or film so as to form a stabilized precursor fiber or film;
(3) removing the thermoplastic resin from the stabilized precursor fiber or film to form a fibrous carbon precursor; and
(4) carbonizing or graphitizing the fibrous carbon precursor to form a carbon fiber.

2. The process according to claim 1, wherein the thermoplastic resin has a free volume diameter at 20° C. measured by a positron extinction method of 0.5 nm or more.

3. The process according to claim 1, wherein the thermoplastic resin is represented by the following formula (I): 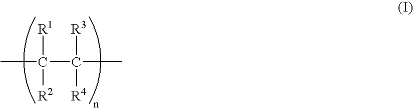
wherein R¹, R², R³ and R⁴ are each independently a hydrogen atom, alkyl group having 1 to 15 carbon atoms, cycloalkyl group having 5 to 10 carbon atoms, aryl group having 6 to 12 carbon atoms or aralkyl group having 7 to 12 carbon atoms, and n is an integer of 20 or more.

4. The process according to claim 1, wherein the thermoplastic resin is at least one selected from the group consisting of homopolymers and copolymers of 4-methylpentene-1 and homopolymers and copolymers of ethylene.

5. The process according to claim 1, wherein the pitch as a thermoplastic carbon precursor is meso-phase pitch.

6. The process according to claim 1, wherein the difference between the surface tension of the thermoplastic resin and the surface tension of the thermoplastic carbon precursor is 15 mN/m or less.

7. The process according to claim 1, wherein the average equivalent diameter of the thermoplastic carbon precursor on the section of the precursor fiber or film is 0.01 to 50 μm.

8. The process according to claim 1, wherein the mixture in the step (1) further contains 0.001 to 20 parts by weight of a polymer selected from the group consisting of (E) a copolymer of a polymer segment (e1) which satisfies the following expression (1) and a polymer segment (e2) which satisfies the following expression (2):
0.7<(surface tension of polymer segment (e1))/(surface tension of thermoplastic carbon precursor)<1.3 (1)
0.7<(surface tension of polymer segment (e2))/(surface tension of thermoplastic resin)<1.3 (2)
and (F) a homopolymer which satisfies the following expressions (3) and (4):
0.7<(surface tension of homopolymer (F))/(surface tension of thermoplastic carbon precursor)<1.3 (3)
0.7<(surface tension of homopolymer (F))/(surface tension of thermoplastic resin)<1.3 (4).

9. The process according to claim 8, wherein the polymer segment (e1) is a styrene homopolymer or copolymer.

10. The process according to claim 8, wherein the polymer segment (e2) is an ethylene homopolymer or copolymer.

11. The process according to claim 8, wherein the copolymer (E) is a graft copolymer or block copolymer.

12. The process according to claim 1, wherein the spinning and film formation of the step (1) are carried out by melt extrusion.

13. The process according to claim 12, wherein the melt extrusion is carried out at a temperature of 100 to 400° C.

14. The process according to claim 12, wherein the film formation is carried out by shearing at 1 to 100,000 S⁻¹.

15. The process according to claim 1, wherein a precursor fiber having an equivalent diameter of 1 to 100 μm or a precursor film having a thickness of 0.1 to 500 μm is formed in the step (1).

16. (canceled)

17. The process according to claim 1, wherein the precursor fiber or film is stretched between the step (1) and the step (2).

18. The process according to claim 1, wherein the removal of the thermoplastic resin in the step (3) is carried out by thermally decomposing the thermoplastic resin at a temperature of 400 to 600° C. to gasify it.

19. The process according to claim 1, wherein carbonization or graphitization in the step (4) is carried out at a temperature of 700 to 3,000° C. in an inert atmosphere.

20. A process for manufacturing a carbon fiber mat, comprising the steps of:
(1) melt extruding a mixture of 100 parts by weight of a thermoplastic resin and 1 to 150 parts by weight of at least one thermoplastic carbon precursor selected from the group consisting of pitch, polyacrylonitrile, polycarbodiimide, polyimide, polybenzazole and aramide to form a precursor film;
(2) subjecting the precursor film to a stabilization treatment to stabilize the thermoplastic carbon precursor contained in the precursor film so as to form a stabilized precursor film;
(3) laminating together a plurality of the stabilized precursor films to form a stabilized precursor laminated film;
(4) removing the thermoplastic resin from the stabilized precursor laminated film to form a fibrous carbon precursor mat; and
(5) carbonizing or graphitizing the fibrous carbon precursor mat to form a carbon fiber mat.

21. A composition for producing fibrous carbon, comprising 100 parts by weight of a thermoplastic resin and 1 to 150 parts by weight of at least one thermoplastic carbon precursor selected from the group consisting of pitch, acrylonitrile, polycarbodiimide, polyimide, polybenzazole and aramide.

22. The composition according to claim 21 which further comprises 0.001 to 20 parts by weight of a polymer selected from the group consisting of (E) a copolymer of a polymer segment (e1) which satisfies the following expression (1) and a polymer segment (e2) which satisfies the following expression (2):
0.7<(surface tension of polymer segment (e1))/(surface tension of thermoplastic carbon precursor)<1.3 (1)
0.7<(surface tension of polymer segment (e2))/(surface tension of thermoplastic resin)<1.3 (2)
and (F) a homopolymer which satisfies the following expressions (3) and (4):
0.7<(surface tension of homopolymer (F))/(surface tension of thermoplastic carbon precursor)<1.3 (3)
0.7<(surface tension of homopolymer (F))/(surface tension of thermoplastic resin)<1.3 (4).

23. The composition according to claim 21 or 22 which is substantially composed of 100 parts by weight of the thermoplastic resin and 1 to 150 parts by weight of the thermoplastic carbon precursor, or of 100 parts by weight of the thermoplastic resin, 1 to 150 parts by weight of the thermoplastic carbon precursor and 0.001 to 20 parts by weight of the copolymer (E) and/or the homopolymer (F).

24. The composition according to claim 21, wherein the thermoplastic carbon precursor is dispersed in the thermoplastic resin matrix in a particulate form and the average equivalent particle diameter of the dispersed thermoplastic carbon precursor is 0.01 to 50 μm.

25. The composition according to claim 21, wherein the average equivalent particle diameter of the dispersed thermoplastic carbon precursor after it is heated at 300° C. for 3 minutes is 0.01 to 50 μm.

26. The composition according to claim 21 prepared by mixing together the thermoplastic resin and the thermoplastic carbon precursor at a temperature at which the melt viscosity of the thermoplastic resin becomes 0.5 to 30 times higher than the melt viscosity of the thermoplastic carbon precursor at a shear rate of 1,000 S⁻¹.

27. Use of the carbon fiber obtained by the process of claim 1 in an electrode for batteries.

28. Use of the carbon fiber obtained by the process of claim 1 to be mixed with a resin.

29. Use of the composition of claim 21 as a raw material for manufacturing a carbon fiber.
